(19) United States
(12) Patent Application Publication
(10) Pub. No.: US 2024/0164260 A1
(43) Pub. Date: May 23, 2024

(54) Pruning Pot Device

(71) Applicant: Juan Contreras, Galt, CA (US)

(72) Inventor: Juan Contreras, Galt, CA (US)

(21) Appl. No.: 18/340,972

(22) Filed: Jun. 26, 2023

Related U.S. Application Data
(60) Provisional application No. 63/427,215, filed on Nov. 22, 2022.

(51) Int. Cl. A01G 9/029

(52) U.S. Cl. CPC A01G 9/0299

(57) ABSTRACT

The present invention relates to a pruning pot device. The device is comprised of a body, a plurality of hinges, and a plurality of latches. The body may be of various sizes to accommodate different plants or trees and may include indicia on any surface. The device further comprises a plurality of openings on the bottom surface of the body, allowing the roots of the plants to grow without obstruction. In addition, the device is comprised of a root blocker to allow the user to block the openings if they wish. The latches allow the device to be secured in a closed position when not in use and the hinges allow the device to be opened and closed. The pruning pot device of the present invention is useful in pruning and cultivating plants and trees with minimal risk of killing the plants.

### CROSS-REFERENCE TO RELATED APPLICATION

The present application claims priority to, and the benefit of, U.S. Provisional Application No. 63/427,215, which was filed on Nov. 22, 2022, and is incorporated herein by reference in its entirety.

### FIELD OF THE INVENTION

The present invention relates generally to the field of flowerpots. More specifically, the present invention relates to a pruning pot device comprised of a body, a plurality of hinges, and a plurality of latches. The device is also comprised of a plurality of openings on the bottom surface of the body allowing the roots of the plants to grow without obstruction. In addition, the device is comprised of a root blocker to allow the user to block the openings as needed. The latches allow the device to be secured in a closed position when not in use. The hinges allow the device to be opened and closed. Accordingly, the present disclosure makes specific reference thereto. Nonetheless, it is to be appreciated that aspects of the present invention are also equally applicable to other like applications, devices, and methods of manufacture.

### BACKGROUND

Plants are an integral part of our daily lives and are often used to decorate and beautify our homes and gardens. Proper care and maintenance of plants is crucial to their health and growth. One important aspect of plant care is pruning which involves removing dead or damaged roots to allow new, healthy roots to grow. This can be a difficult and time-consuming task, particularly for plants with a dense root system or for plants that are difficult to repot.

Conventional flowerpots do not allow for easy access to the roots, making it difficult to properly prune and care for the plant. This can lead to overcrowding of the roots, which can hinder the plant's growth and overall health. Overcrowded roots can also make it difficult to repot the plant, as the roots may become tangled or damaged during the transfer process. In addition, repotting a plant can be a challenging task as it requires the user to carefully remove the plant from the pot and disturb the root system. This can be stressful for the plant and may even result in death if not done properly.

Therefore, there exists a long-felt need in the art for an improved flowerpot. There also exists a long-felt need in the art for a flowerpot that allows for easy access to the roots for pruning and maintenance. Further, there exists a long-felt need in the art for a flowerpot that can be easily opened from the side to access the roots rather than requiring the plant to be removed from the pot. There also exists a long-felt need in the art for a flowerpot that prevents overcrowding of the roots and improves the overall health and growth of the plant. In addition, there exists a long-felt need in the art for a flowerpot that is easy to use and does not disturb the root system when repotting the plant.

The subject matter disclosed and claimed herein, in one embodiment thereof, comprises a pruning pot device. The device is comprised of a body, a plurality of hinges, and a plurality of latches. The device is also comprised of a plurality of openings on the bottom surface of the body, allowing the roots of the plants to grow without obstruction. The latches are attached to the top and bottom of the side surface of the body and allow the device to be secured in a closed position when not in use. The hinges are attached to the top and bottom of the side surface of the body opposite from the latches, allowing the device to be opened and closed. The pruning pot device of the present invention is useful in pruning and cultivating plants and trees with minimal risk of killing the plants.

In this manner, the pruning pot device of the present invention accomplishes all of the foregoing objectives and provides a solution for easily accessing and pruning the roots of a plant. The device allows for improved care and maintenance of the plant resulting in better health and growth. The pruning pot device also provides a secure closure for the pot preventing any accidents or spills and making it suitable for use in any environment. Additionally, the pruning pot device helps to extend the lifespan of the pot by preventing overcrowding of the roots.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pruning pot device. The pruning pot device is primarily comprised of a body, a plurality of hinges, and a plurality of latches. In differing embodiments, the body may have the appearance of a plurality of differing types of flowerpots or flower troughs. However, in the preferred embodiment, the body resembles a standard cylindrical flowerpot. The body may also be made of a metal or ceramic material that may commonly be used for making flowerpots. However, the body is preferably made of a flexible or semi-flexible plastic material. In differing embodiments, the body may be a plurality of sizes such as, but not limited to, small, medium, and large. In this manner, the device can be any size in order to accommodate differing sized plants or trees. In addition, any surface of the body may be comprised of a plurality of indicia such as patterns, logos, emblems, images, symbols, designs, letters, words, characters, animals, advertisements, brands, etc., that may or may not be flower or flowerpot related.

The body is also comprised of a plurality of openings. The openings are positioned on the bottom surface of the body and allow for the roots of the plants to freely grow without obstruction. In the preferred embodiment, the openings are a size that allow the roots to grow properly. In a differing embodiment, the openings may be any size. In this manner, the user is easily able to prune the roots to a safe length as to not kill the plant.

The body is also comprised of a root blocker. In the preferred embodiment, the root blocker is removable from the body of the device. The root blocker can be placed inside the bottom of the body in order to prevent the roots from growing through the openings. In the preferred embodiment, the root blocker is manufactured from a flexible or semi-flexible plastic material. In a differing embodiment, the root blocker may be manufactured from a metal material.

In the preferred embodiment, the latches may be any latch known in the art which provides a secure attachment point. The latches are fixedly attached to the top and bottom of the side surface of the body such that the device can be fixed in a closed position when the user is not pruning the plant. In the preferred embodiment, the latches are manufactured from a metal material.

In the preferred embodiment, the hinges may be any hinge known in the art which allows the device to open and close. The hinges are fixedly attached to the top and bottom of the side surface of the body opposite from the latches. In this manner, the hinges allow the device to be opened or closed. In the preferred embodiment, the hinges are manufactured from a metal material.

Accordingly, the pruning pot device of the present invention is particularly advantageous as it provides a solution for easily accessing and pruning the roots of a plant. The device allows for improved care and maintenance of the plant resulting in better health and growth. The pruning pot device also provides a secure closure for the pot preventing any accidents or spills and making it suitable for use in any environment. Additionally, the pruning pot device helps to extend the lifespan of the plant by preventing overcrowding of the roots. In this manner, the pruning pot device overcomes the limitations of existing pruning pots known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of a pruning pot device of the present invention in accordance with the disclosed architecture; and

FIG. 2 illustrates a bottom perspective view of one potential embodiment of a pruning pot device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a flowerpot that allows for easy access to the roots for pruning and maintenance. Further, there exists a long-felt need in the art for a flowerpot that can be easily opened from the side to access the roots rather than requiring the plant to be removed from the pot. There also exists a long-felt need in the art for a flowerpot that prevents overcrowding of the roots and improves the overall health and growth of the plant. In addition, there exists a long-felt need in the art for a flowerpot that is easy to use and does not disturb the root system when repotting the plant.

The present invention, in one exemplary embodiment, is comprised of a pruning pot device. The pruning pot device is primarily comprised of a body, a plurality of hinges, and a plurality of latches. In differing embodiments, the body may have the appearance of a plurality of differing types of flowerpots or flower troughs. However, in the preferred embodiment the body resembles a standard cylindrical flowerpot. The body may also be made of a metal or ceramic material that may commonly be used for making flowerpots. However, the body is preferably made of a flexible or semi-flexible plastic material. In differing embodiments, the body may be a plurality of sizes such as, but not limited to, small, medium, and large. In this manner, the device can be any size in order to accommodate differing sized plants or trees. In addition, any surface of the body may be comprised of a plurality of indicia such as patterns, logos, emblems, images, symbols, designs, letters, words, characters, animals, advertisements, brands, etc., that may or may not be flower or flowerpot related.

The body is also comprised of a plurality of openings. The openings are positioned on the bottom surface of the body and allow for the roots of the plants to freely grow without obstruction. In the preferred embodiment, the openings are a size that allow the roots to grow properly. In a differing embodiment, the openings may be any size. In this manner, the user is easily able to prune the roots to a safe length as to not kill the plant.

The body is also comprised of a root blocker. In the preferred embodiment, the root blocker is removable from the body of the device. The root blocker can be placed inside the bottom of the body in order to prevent the roots from growing through the openings. In the preferred embodiment, the root blocker is manufactured from a flexible or semi-flexible plastic material. In a differing embodiment, the root blocker may be manufactured from a metal material.

In the preferred embodiment, the latches may be any latch known in the art which provides a secure attachment point. The latches are fixedly attached to the top and bottom of the side surface of the body such that the device can be fixed in a closed position when the user is not pruning the plant. In the preferred embodiment, the latches are manufactured from a metal material.

In the preferred embodiment, the hinges may be any hinge known in the art which allow the device to open and close. The hinges are fixedly attached to the top and bottom of the side surface of the body opposite from the latches. In this manner, the hinges allow the device to be opened or closed. In the preferred embodiment, the hinges are manufactured from a metal material.

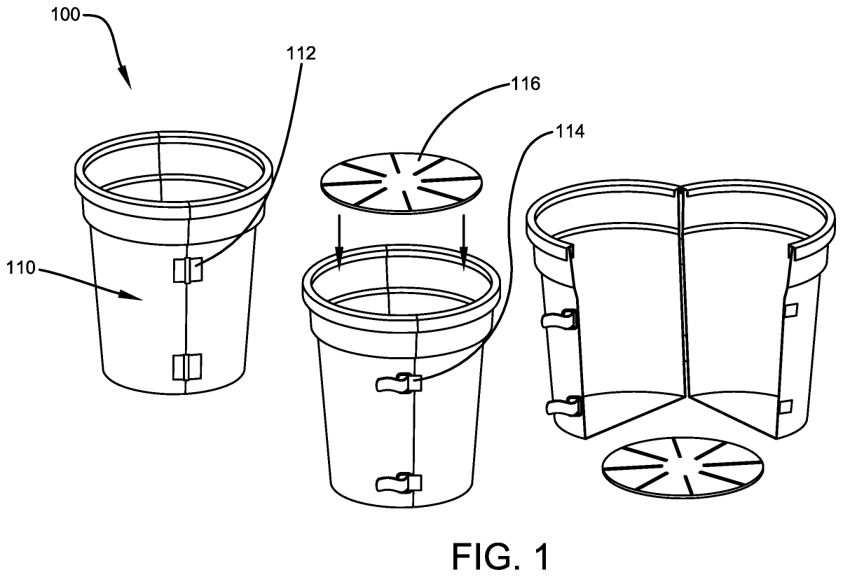

Referring initially to the drawings, FIG. 1 illustrates a front perspective view of one potential embodiment of a pruning pot device 100 of the present invention in accordance with the disclosed architecture. The device 100 is primarily comprised of a body 110, at least one hinge 112, and at least one latch 114. In differing embodiments, the body 110 may have the appearance of a plurality of differing types of flowerpots or flower troughs such as, but not limited to, traditional flowerpots, hanging flowerpots, self-watering flowerpots, raised bed flowerpots, wall-mounted flowerpots, vertical planters, biodegradable flowerpots, recycled flowerpots, self-contained ecosystems, aquatic flowerpots, etc. However, in the preferred embodiment, the body 110 resembles a standard cylindrical flowerpot.

The body 110 may also be made of a metal or ceramic material that may commonly be used for making flowerpots. However, the body 110 is preferably made of a flexible or semi-flexible plastic material such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc. In differing embodiments, the body 110 may be a plurality of sizes such as, but not limited to, small, medium, large, extra-large, etc. In this manner, the device 100 can be any size in order to accommodate differing sized plants or trees. In the preferred embodiment, the body 110 is in the shape of a cylinder. In differing embodiments, the body 110 may be any shape known in the art such as, but not limited to, a square, a rectangle, a circle, a triangle, an oval, a diamond, a pentagon, a hexagon, an octagon, a star, etc.

The body 110 is also comprised of at least one root blocker 116. In the preferred embodiment, the root blocker 116 is removable from the body 110 of the device 100. The root blocker 116 can be placed inside the bottom surface of the body 110 in order to prevent the roots from growing through the openings 118. In the preferred embodiment, the root blocker 116 is manufactured from a flexible or semi-flexible plastic material.

The device 100 is also comprised of at least one latch 114. In the preferred embodiment, the latches 114 may be any latch such as, but not limited to, a padlock latch, a bolt latche, a hook and eye latch, a deadbolt latch, a barrel bolt latch, a spring latch, a sliding latch, a flush latch, a cam latch, a claw latch, etc. In this manner, the latches 114 can provide a secure attachment point to close the body 110 of the device 100. The latches 114 are fixedly attached to the top and bottom of the side surface of the body 110 such that the device can be fixed in a closed position when the user is not pruning the plant.

In the preferred embodiment, the hinges 112 may be any hinge such as, but not limited to, an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge, a locking hinge, etc. In this manner, the hinges 112 allow the body 110 of the device 100 to open and close, wherein the body has a first half and a second half connected by the hinge 112. The hinges 112 are fixedly attached to the top and bottom of the side surface of the body 110 opposite from the latches 114.

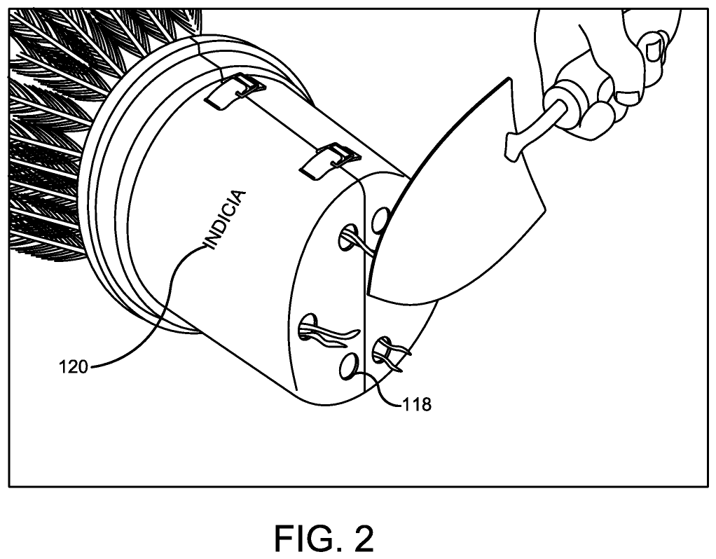

FIG. 2 illustrates a bottom perspective view of one potential embodiment of a pruning pot device 100 of the present invention in accordance with the disclosed architecture. The body 110 is also comprised of a plurality of indicia 120. The indicia 120 can be any indicia such as, but not limited to, patterns, logos, emblems, images, symbols, designs, letters, words, characters, animals, advertisements, brands, etc., that may or may not be flower or flowerpot related.

The body 110 is also comprised of at least one opening 118. The opening 118 is positioned on the bottom surface of the body 110 and allows for the roots of the plants to freely grow without obstruction. In the preferred embodiment, the opening 118 is a size that allows the roots to grow properly. In a differing embodiment, the opening 118 may be any size. In this manner, the user is easily able to prune the roots to a safe length as to not kill the plant.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “pruning pot device” and “device” are interchangeable and refer to the pruning pot device 100 of the present invention.

Notwithstanding the foregoing, the pruning pot device 100 of the present invention and its various components can be of any suitable size and configuration as is known in the art without affecting the overall concept of the invention, provided that they accomplish the above-stated objectives. One of ordinary skill in the art will appreciate that the size, configuration and material of the pruning pot device 100 as shown in the FIGS. are for illustrative purposes only, and that many other sizes and shapes of the pruning pot device 100 are well within the scope of the present disclosure. Although the dimensions of the pruning pot device 100 are important design parameters for user convenience, the pruning pot device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pruning pot device comprising:
a body;
a hinge;
a latch;
a root blocker; and
an opening.

2. The pruning pot device of claim 1, wherein the body is comprised of a flowerpot.

3. The pruning pot device of claim 1, wherein the body is comprised of a metal or a ceramic material.

4. A pruning pot device comprising:
a body comprised of a first half and a second half;
a hinge;
a latch;
a root blocker; and
an opening.

5. The pruning pot device of claim 1, wherein the root blocker is comprised of a circular shape.

6. The pruning pot device of claim 1, wherein the hinge is positioned on the first half.

7. The pruning pot device of claim 1, wherein the hinge connects the first half to the second half.

8. The pruning pot device of claim 1, wherein the latch is positioned on the second half.

9. The pruning pot device of claim 1, wherein the latch secures the first half to the second half.

10. A pruning pot device comprising:
a body comprised of a first half and a second half;
a hinge that connects the first half to the second half;
a latch that secures the first half to the second half;
a root blocker; and
an opening positioned on the body.

11. The pruning pot device of claim 10, wherein the opening is positioned on a bottom surface of the body.

12. The pruning pot device of claim 10 further comprised of an indicia.

13. The pruning pot device of claim 10, wherein the body is comprised of a flexible plastic material.

14. The pruning pot device of claim 10, wherein the root blocker is positioned within the body.

15. The pruning pot device of claim 10, wherein the root blocker is removable from the body.

16. The pruning pot device of claim 11, wherein the opening is comprised of a plurality of openings.

17. The pruning pot device of claim 16, wherein the plurality of openings is six.

18. The pruning pot device of claim 17, wherein the root blocker is sized and configured to cover the plurality of openings.

19. The pruning pot device of claim 18, wherein the root blocker is repositionable relative to the body.

20. The pruning pot device of claim 18, wherein the root blocker is circular in shape.
